(19) United States
(12) Patent Application Publication
(10) Pub. No.: US 2026/0278627 A1
(43) Pub. Date: Sep. 17, 2026

(54) INFORMATION PROMOTION METHOD, ELECTRONIC DEVICE AND STORAGE MEDIUM

(71) Applicant: Beijing Youzhuju Network Technology Co., Ltd., Beijing (CN)

(72) Inventors: Fengyu HAN, Beijing (CN); Kunjie TANG, Beijing (CN); Peng QI, Beijing (CN)

(21) Appl. No.: 19/534,719

(22) Filed: Feb. 9, 2026

(30) Foreign Application Priority Data
Mar. 12, 2025 (CN) 202510293203.2

(51) Int. Cl. G06Q 30/0202; G06N 3/09

(52) U.S. Cl. CPC G06Q 30/0202; G06N 3/09

(57) ABSTRACT

The present disclosure provides an information promotion method, an electronic device, and a non-transitory computer-readable storage medium. The method includes: determining a predicted sales volume of each cold start object in a cold start object pool based on a sales prediction model, where the sales prediction model is a supervised fine-tuned large language model; determining at least one candidate cold start object based on the predicted sales volume of each cold start object; selecting a target object for information promotion from the at least one candidate cold start object and a candidate non-cold start object; and promoting the target object.

### CROSS-REFERENCE TO RELATED APPLICATION

The present disclosure claims priority to and benefits of the Chinese Patent Application No. 202510293203.2, filed on Mar. 12, 2025, the disclosure of which is incorporated herein by reference in its entirety as part of the present application.

### TECHNICAL FIELD

The present disclosure relates to the field of computer technologies, and in particular, to an information promotion method, an electronic device and a storage medium.

### BACKGROUND

At present, when introducing new products, an e-commerce platform usually has difficulty in selecting a large number of products across the network. For example, product information across the network usually includes a large amount of unstructured text data, such as product titles, descriptions, and so on, but lacks statistical data such as sales volume. As a result, the accuracy and effectiveness of product selection across the network are both low. However, it is also quite difficult to predict product sales volume. In particular, in a long-tailed distributed product scenario, the deviation of product sales volume prediction is usually relatively large.

### SUMMARY

In view of this, an embodiment of the present disclosure provides an information promotion method. Through supervised fine-tuning of a large language model, the sales volume prediction capability for a cold start object can be improved, the cold start object is helped to quickly break the cold start period, and the performance of the cold start object in an e-commerce platform is improved, thereby improving the user experience.

The information promotion method according to the embodiment of the present disclosure may include: determining a predicted sales volume of each cold start object in a cold start object pool based on a sales prediction model, where the sales prediction model is a supervised fine-tuned large language model; determining at least one candidate cold start object based on the predicted sales volume of each cold start object; selecting a target object for information promotion from the at least one candidate cold start object and a candidate non-cold start object; and promoting the target object.

The information promotion method according to the embodiment of the present disclosure may further include: constructing a training dataset, where the training dataset includes a plurality of training samples and discrete sales labels corresponding to the training samples; generating a sales prediction prompt for each training sample in the training dataset; inputting the sales prediction prompt into a large language model; obtaining a plurality of predicted sales volumes corresponding to the plurality of training samples and output by the large language model; determining a loss between a predicted sales volume corresponding to a training sample and a discrete sales label corresponding to the training sample for each training sample; and performing supervised fine-tuning on the large language model based on the loss to obtain the supervised fine-tuned large language model.

The constructing a training dataset according to the embodiment of the present disclosure includes: labeling each sample of a plurality of samples in a preset sample dataset with a sales value corresponding to the sample; for a sample with a sales label value of zero, setting the discrete sales label corresponding to the sample to zero; for a sample with a non-zero sales label value, dividing the sample into N sample groups according to a preset number of groups N and an N quantile to which the sales label value corresponding to the sample belongs, and setting a same discrete sales label for samples in each sample group, respectively, where the larger the sales label value, the larger the discrete sales label set for the sample group where the sample is located in, and N is a positive integer; and for each discrete sales label, extracting a predetermined number of samples from samples corresponding to the discrete sales label as the training samples.

In the embodiment of the present disclosure, the generating a sales prediction prompt for each training sample in the training dataset includes: generating the sales prediction prompt based on a preset sales prediction prompt template and feature information of the training sample, where the feature information of the training sample includes one or more selected form a group of: basic information of an object, picture information of the object, stock keeping unit (SKU) configuration information of the object, price information of the object, and seller information of the object; and the preset sales prediction prompt template includes: a role description part, background information part, an input data description part, an output requirement part, and a special description part.

In the embodiment of the present disclosure, the determining at least one candidate cold start object based on the predicted sales volume of each cold start object includes: adding at least one cold start object with a predicted sales volume greater than a preset sales threshold to a cold start object recall pool; performing pre-ranking on cold start objects in the cold start object recall pool based on feature information of the cold start objects, and selecting a predetermined number of cold start objects from the cold start objects and adding the predetermined number of cold start objects to a ranking pool according to a pre-ranking result; performing ranking on cold start objects in the ranking pool based on the feature information of the cold start objects; and determining the at least one candidate cold start object from the cold start objects in the ranking pool according to a ranking result.

In the embodiment of the present disclosure, the determining at least one candidate cold start object based on the predicted sales volume of each cold start object includes: adding at least one cold start object with a predicted sales volume greater than a preset sales threshold to a cold start object recall pool; performing pre-ranking on cold start objects in the cold start object recall pool based on feature information of the cold start objects and the predicted sales volumes of the cold start objects, and selecting a predetermined number of cold start objects from the cold start objects and adding the predetermined number of cold start objects to a ranking pool according to a pre-ranking result; performing ranking on cold start objects in the ranking pool based on the feature information of the cold start objects; and determining the at least one candidate cold start object from the cold start objects in the ranking pool according to a ranking result.

In the embodiment of the present disclosure, the determining at least one candidate cold start object based on the predicted sales volume of each cold start object includes: adding at least one cold start object with a predicted sales volume greater than a preset sales threshold to a cold start object recall pool; performing pre-ranking on cold start objects in the cold start object recall pool based on feature information of the cold start objects and predicted sales volumes of the cold start objects, and selecting a predetermined number of cold start objects from the cold start objects and adding the predetermined number of cold start objects to a ranking pool according to a pre-ranking result; performing ranking on cold start objects in the ranking pool based on the feature information of the cold start objects and the predicted sales volumes of the cold start objects; and determining the at least one candidate cold start object from the cold start objects in the ranking pool according to a ranking result.

In the embodiment of the present disclosure, the performing pre-ranking on cold start objects in the cold start object recall pool based on feature information of the cold start objects and predicted sales volumes of the cold start objects includes: performing following operations for each cold start object in the cold start object recall pool: determining a pre-ranking feature indicator of the cold start object based on the feature information of the cold start object, and performing weighted summation on the predicted sales volume of the cold start object and the feature indicator of the cold start object to obtain a pre-ranking comprehensive indicator of the cold start object, where a sum of a weight coefficient of the predicted sales volume of the cold start object and a weight coefficient of the pre-ranking feature indicator of the cold start object is equal to 1; and performing pre-ranking on the cold start objects in the cold start object recall pool based on the pre-ranking comprehensive indicator of the cold start object.

In the embodiment of the present disclosure, the performing ranking on cold start objects in the ranking pool based on the feature information of the cold start objects and predicted sales volumes of the cold start objects includes: determining a plurality of ranking features based on the feature information of the cold start objects and the predicted sales volumes of the cold start objects, where the predicted sales volume of the cold start object is used as one of the plurality of ranking features; and performing ranking on the cold start objects in the ranking pool based on the plurality of ranking features.

In the embodiment of the present disclosure, the determining a target object for information promotion from the at least one candidate cold start object and a candidate non-cold start object includes: performing hybrid ranking on the at least one candidate cold start object and the candidate non-cold start object; and determining the target object based on a hybrid ranking result.

Corresponding to the information promotion method described above, an embodiment of the present disclosure further discloses an information promotion apparatus, which includes:
a sales prediction module, configured to determine a predicted sales volume of each cold start object in a cold start object pool based on a sales prediction model, where the sales prediction model is a supervised fine-tuned large language model;
a candidate cold start object determination module, configured to determine at least one candidate cold start object based on the predicted sales volume of each cold start object;
a target object determination module, configured to select a target object for information promotion from the at least one candidate cold start object and a candidate non-cold start object; and
an information promotion module, configured to promote the target object.

In addition, an embodiment of the present disclosure further provides an electronic device, which includes: a memory, a processor, and a computer program stored on the memory and executable on the processor, where the computer program, when executed by the processor, causes the information promotion method described above to be implemented.

An embodiment of the present disclosure further provides a non-transitory computer-readable storage medium, which stores computer instructions, where the computer instructions are used to cause a computer to perform the information promotion method described above.

An embodiment of the present disclosure further provides a computer program product, which includes computer program instructions that, when executed on a computer, cause the computer to perform the information promotion method described above.

It can be seen that according to the information promotion method and the related apparatus, a sales prediction model capable of accurately predicting the sales volume of a cold start object can be obtained by performing supervised fine-tuning on a large language model. At least one candidate cold start object is selected from a cold start object pool based on the sales volume predicted by the sales prediction model, and participates in determining a target object for information promotion together with other candidate non-cold start objects, to promote information of the target object. It can be seen that the above solution helps the cold start object to quickly break the cold start period by improving the sales prediction capability for the cold start object, improves the performance of the cold start object in an e-commerce platform, and greatly improves the user experience.

### BRIEF DESCRIPTION OF DRAWINGS

In order to more clearly illustrate the technical solutions in the present disclosure or in the related art, the following briefly introduces the drawings required for describing the embodiments or the related art. Apparently, the drawings in the following description show merely some embodiments of the present disclosure, and a person of ordinary skill in the art may still derive other drawings from these drawings without creative efforts.

FIG. 1 shows a procedure of implementing an information promotion method according to some embodiments of the present disclosure.

FIG. 2 shows a procedure of implementing a method for supervised fine-tuning of a large language model according to some embodiments of the present disclosure.

FIG. 3 shows a procedure of implementing a specific method for constructing a training dataset according to some embodiments of the present disclosure.

FIG. 4 shows a method for determining at least one candidate cold start object from a cold start object pool based on predicted sales volumes of the cold start objects according to some embodiments of the present disclosure.

FIG. 5 shows a method for determining at least one candidate cold start object from a cold start object pool based on predicted sales volumes of the cold start objects according to some other embodiments of the present disclosure.

FIG. 6 shows a method for determining at least one candidate cold start object from a cold start object pool based on predicted sales volumes of the cold start objects according to some further embodiments of the present disclosure.

FIG. 7 shows an internal structure of an information promotion apparatus according to some embodiments of the present disclosure.

FIG. 8 shows a schematic diagram of a more specific hardware structure of an electronic device according to some embodiments of the present disclosure.

### DETAILED DESCRIPTION

In order to make the objectives, technical solutions, and advantages of the present disclosure clearer, the present disclosure is further described in detail below with reference to specific embodiments and the drawings.

It should be noted that unless otherwise defined, the technical or scientific terms used in the embodiments of the present disclosure shall have general meanings as understood by those of ordinary skill in the art to which the present disclosure belongs. “First”, “second”, and like words used in the embodiments of the present disclosure do not represent any order, quantity, or importance, but are merely used to distinguish between different components. “Include” or “comprise” or like words mean that an element or item preceding the term encompasses an element or item or its equivalent listed after the term, without excluding other elements or items. “Connect” or “connected” or like words are not limited to a physical or mechanical connection, but may include an electrical connection, whether direct or indirect. “Up”, “down”, “left”, “right”, and the like are merely used to represent a relative positional relationship, and the relative positional relationship may change accordingly when an absolute position of the described object changes.

It may be understood that before the use of the technical solutions in the embodiments of the present disclosure, the user shall be informed of the type, range of use, use scenarios, etc., of involved personal information in an appropriate manner, and the authorization of the user shall be obtained.

For example, in response to reception of an active request from a user, prompt information is sent to the user to clearly inform the user that the requested operation will require access to and use of personal information of the user. As such, the user may independently choose, based on the prompt information, whether to provide the personal information to software or hardware, such as an electronic device, an application, a server, or a storage medium, that performs the operations of the technical solutions of the present disclosure.

As an optional but non-limiting implementation, in response to the reception of the active request from the user, the prompt information may be sent to the user in the form of, for example, a pop-up window, in which the prompt information may be presented in text. Furthermore, the pop-up window may also include a selection control for the user to choose whether to “agree” or “disagree” to provide the personal information to the electronic device.

It may be understood that the above process of notifying and obtaining user authorization is only illustrative and does not constitute a limitation on the implementations of the present disclosure, and other manners that satisfy relevant laws and regulations may also be applied in the implementations of the present disclosure.

For the sake of clarity of description, before the description of the specific technical solutions of the embodiments of the present disclosure, several technical terms involved in the embodiments of the present disclosure are first explained.

A large language model (LLM) is a neural network model used for natural language processing tasks and having a large number of parameters and a complex structure. The LLM is trained by using massive data, and deep learning techniques are used to learn basic patterns and structures of a language. Compared with small models, the LLM may achieve higher performance on various tasks and generally has better generalization.

Supervised fine-tuning (SFT) refers to a process of fine-tuning a pre-trained neural network model by using new labeled data to improve its performance.

A prompt is an injection-style instruction used to “control” a large model to think about a problem and output content according to a preset train of thought. A prompt is an instruction or information that guides or triggers the large model to make a response.

An object refers to a product, a merchandise, or an information content involved in an e-commerce platform in the embodiments of the present disclosure.

A cold start object refers to a product or a merchandise that is newly added to an e-commerce platform. Generally, the sales volume corresponding to a cold start object is usually zero.

A cold start object pool refers to a set composed of all cold start objects on an e-commerce platform.

A non-cold start object refers to a merchandise, a product, or an information content involved in an e-commerce platform. For a non-cold start merchandise or product, its sales volume is usually not zero.

Information promotion refers to exposing some or all feature information of the above object for browsing by users of the e-commerce platform.

As described above, an e-commerce platform usually has difficulty in selecting products from a large number of products across a network when introducing new products. To this end, an embodiment of the present disclosure provides an information promotion method.

FIG. 1 shows a procedure of implementing an information promotion method according to an embodiment of the present disclosure. As shown in FIG. 1, the information promotion method according to the embodiment of the present disclosure may include the following steps.

At step 110, a predicted sales volume of each cold start object in a cold start object pool is determined based on a sales prediction model. In the embodiment of the present disclosure, the sales prediction model is a supervised fine-tuned large language model.

At step 120, at least one candidate cold start object is determined based on the predicted sales volume of each cold start object.

At step 130, a target object for information promotion is selected from the at least one candidate cold start object and a candidate non-cold start object.

At step 140, the target object is promoted.

It may be seen that in the embodiment of the present disclosure, during an information promotion process, the sales prediction model may be first used to predict the sales volume of each cold start object in the cold start object pool, and a cold start object with sales potential is selected from the cold start objects and added to the target object for information promotion based on the predicted sales volume output by the sales prediction model. This helps the cold start object quickly break a cold start period, improves the performance of the cold start object in the e-commerce platform, and greatly improves the user experience.

The specific implementation method for each step in the embodiment of the present disclosure is described in detail below with reference to specific examples.

As described above, in step 110, the sales prediction model is a supervised fine-tuned large language model. A specific method for supervised fine-tuning of a large language model in an embodiment of the present disclosure is described in detail below with reference to a specific example.

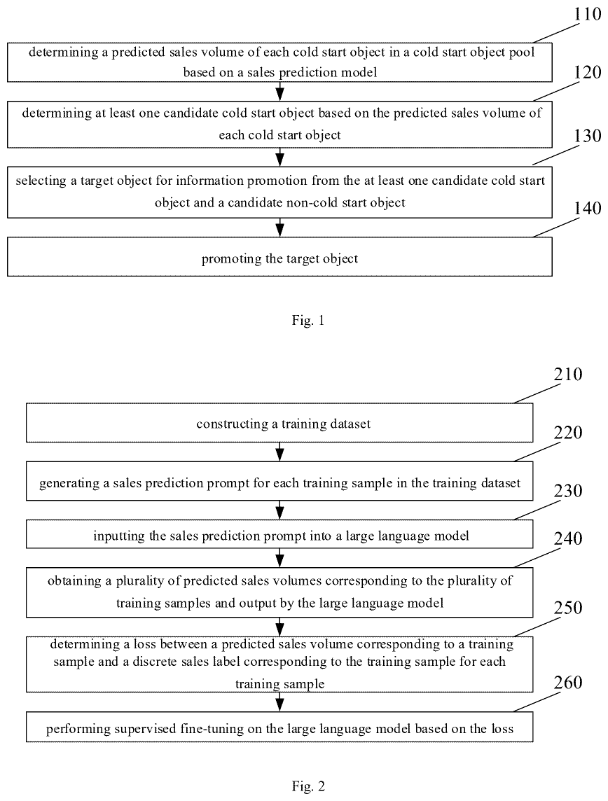

FIG. 2 shows a procedure of implementing a method for supervised fine-tuning of a large language model according to an embodiment of the present disclosure. As shown in FIG. 2, the specific method for supervised fine-tuning of the large language model includes the following steps.

At step 210, a training dataset is constructed.

In the embodiment of the present disclosure, the training dataset may include a plurality of training samples and discrete sales labels corresponding to the training samples. Specifically, considering the long-tailed distribution and category imbalance of sales values of various products on an e-commerce platform, in the embodiment of the present disclosure, a sales prediction task is first transformed into a sales scoring task. That is, a discrete sales label instead of an actual sales value is used to represent the sales volume of an object, to address challenges faced by a traditional sales prediction model, such as the long-tailed distribution and difficulty in sales order consistency. Specifically, in the embodiment of the present disclosure, first, a sales value corresponding to each training sample is discretely quantified as one specific value from 0 to A (for example, a scoring range of 0 to 9 or 0 to 10), where a higher value represents a higher sales volume corresponding to the training sample, thereby avoiding instability and model deviation that may be caused by direct prediction of the sales value. That is, in the embodiment of the present disclosure, the discrete sales label is a value obtained by quantifying the sales value of the training sample.

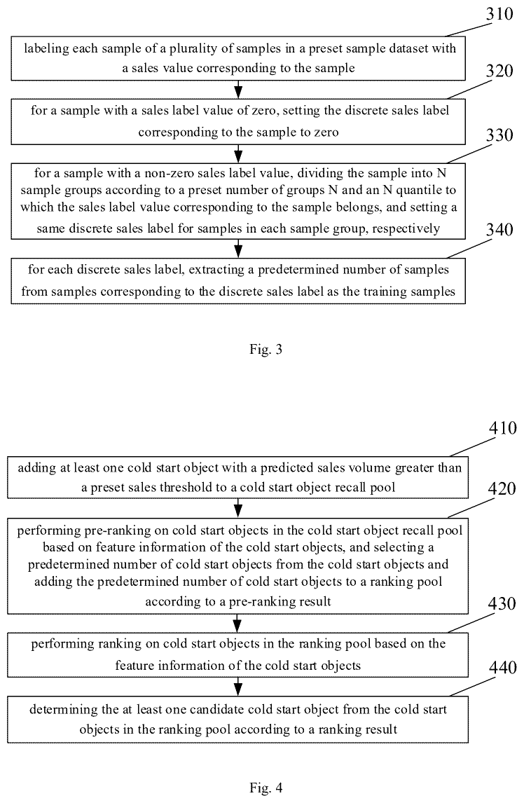

Based on the above, in the embodiment of the present disclosure, a specific method for constructing the training dataset may be as shown in FIG. 3, including the following steps.

At step 310, each sample of a plurality of samples in a preset sample dataset is labeled with a sales value corresponding the sample.

In the embodiment of the present disclosure, the sample may correspond to a certain object described above, and include various feature information of the object. In the embodiment of the present disclosure, the feature information may include one or any combination of the following information: basic information of the object, picture information of the object, stock keeping unit (SKU) configuration information of the object, price information of the object, and seller information of the object, etc. The feature information will be used for supervised fine-tuning of the large language model, with the goal of enabling the large language model to have a deeper understanding of the features of the sample.

Specifically, the basic information of the object may include one or any combination of the following information:
a title of the object: which reflects the main information of the object and may be used as the core text input to the large language model;
a category of the object: which helps the large language model understand the classification and use of the object; and
description information of the object: from which the large language model may extract and analyze key phrases and important information to support feature learning.

The picture information of the object may include one or any combination of the following information:
address information (URL) of a main picture: which serves as one of the important features of the object;
a picture list: which includes the URLs of all associated pictures of the corresponding object and the order of the associated pictures, and is used to enhance the comprehensive understanding of the object display by the large language model; and
picture positions: which are used to guide the large language model to determine the visual display logic of the object in combination with the picture order.

The SKU configuration information of the object may include one or any combination of the following information:
the number of SKUs: which reflects the inventory and variety diversity of the object; and

SKU size information: which is used to guide the large language model to analyze the specific configurations (such as size and color, etc.) available for the object.

The price information of the object may include one or any combination of the following information:
a minimum SKU price: which provides the lowest price of the object as the lower bound of the pricing;
a maximum SKU price: which provides the highest price of the object and reflects the price range; and
price changes: which are used to guide the large language model to capture the impact of price elasticity and promotion behavior through historical price fluctuation trends.

The seller information of the object may include one or any combination of the following information:
a main business category: which is used to guide the large language model to locate the main category of products managed by the seller and the specialization degree of the seller.

Description: which is used to guide the large language model to analyze the description of the seller to identify its service features.

Multi-platform presence: which is used to guide the large language model to evaluate the market coverage breadth of the seller and its operation performance on different platforms.

Furthermore, in the embodiment of the present disclosure, the labeling described in step 310 may be implemented through manual labeling or other labeling methods. The labeling process may be obtained by analyzing historical sales data and trends of the object sample, to ensure high data quality and consistency.

Furthermore, it should be noted that for the preset sample dataset, before the data labeling described in step 310, data cleaning first needs to be performed to remove outliers therefrom, and deduplication processing is performed on the data, etc., to ensure that the data in the sample dataset is clean and efficient.

At step 320, for a sample with a sales label value of zero, a discrete sales label corresponding to the sample is set to zero.

As described above, in the embodiment of the present disclosure, the sample with the sales label value of zero may be considered as a sample of the cold start object according to the embodiment of the present disclosure.

At step 330, for a sample with a non-zero sales label value, the sample is divided into N sample groups according to a preset number of groups N and an N quantile to which the sales label value corresponding to the sample belongs, and a same discrete sales label is set for samples in each sample group, where a larger the sales label value, a larger the discrete sales label set for the sample group where the sample is located, and N is a positive integer.

For example, in a specific example, the discrete sales label may be set to include eleven values from 0 to 10, where a discrete sales label of 0 represents a sales value of 0 for the training sample (cold start object sample). The sales values of the training samples corresponding to the discrete sales labels 1 to 10 are all non-zero (non-cold start object samples). Specifically, the discrete sales labels 1 to 10 respectively represent the ranking of the decile in which the sales volume of the training sample is located. For example, a discrete sales label of 10 represents that the sales volume of the training sample belongs to the highest top 10%; a discrete sales label of 9 represents that the sales volume of the training sample belongs to the higher top 11% to 20%; . . . ; and a discrete sales label of 1 represents that the sales volume of the training sample belongs to the lowest 10%. That is, a larger the value corresponding to the discrete sales label, a larger the sales value. The specific values of the discrete sales label are only examples, and in the embodiment of the present disclosure, other values of N may be selected and the discrete sales label may be determined based on the selected value of N.

It may be understood that the method for setting the discretized sales label ensures the stability of the sales prediction model in dealing with the sales value fluctuation and imbalance problems, and avoids model deviation that may be caused by the sales value fluctuation and the long-tail effect.

At step 340, for each discrete sales label, a predetermined number of samples are extracted from samples corresponding to the discrete sales label and used as training samples.

Considering that the sales volume of many samples is relatively low, if the supervised fine-tuning of the large language model is performed based on all samples, it will be difficult for the large language model to fully learn the relevant features of objects with high sales volume. To address this problem, in the embodiment of the present disclosure, for each discrete sales label, a predetermined number of samples are extracted from the samples corresponding to the discrete sales label and used as training samples. For samples with non-zero discrete sales labels (i.e., objects with sales), stratified uniform sampling may be performed. For example, substantially the same predetermined number is set for sampling of samples with non-zero discrete sales labels, that is, the same number of samples are extracted for each discrete sales label. For example, in the above example, 5000 samples may be selected from the training samples with discrete sales labels of 1 to 10, respectively, and used as the training samples. Through this stratified uniform sampling method, information of samples with high sales volume may be enhanced, so that the large language model may learn more relevant features of the samples with high sales volume, thereby improving the prediction capability thereof. To improve the discrimination capability of the large language model, especially the prediction capability for cold start objects (objects without sales, i.e., discrete sales label is zero), an equal order of magnitude of samples may be added as negative samples for supervised fine-tuning of the large language model. For example, in the above example, in addition to respectively selecting 5000 samples from the training samples with discrete sales labels of 1 to 10 and using the samples as the training samples, 5000 to 10000 samples are further selected from the training samples with a discrete sales label of 0 and added to the training samples. This approach may effectively balance the proportion of positive and negative classes of samples, and enhance the identification and prediction capability of the large language model for cold start samples.

It may be understood that the distribution of the training samples in the training dataset may be greatly optimized through sample sampling based on sales value quantiles and sales label discretization described above, and the rank correlation and prediction accuracy of the large language model may be effectively improved after supervised fine-tuning of the large language model based on such training dataset.

At step 220, a sales prediction prompt is generated for each training sample in the training dataset.

In the embodiment of the present disclosure, step 220 may specifically include: generating the sales prediction prompt based on a preset sales prediction prompt template and feature information of the training sample, where the preset sales prediction prompt template may include: a role description part, a background information part, an input data description part, an output requirement part, and a special description part. The role description part is used to inform the large language model of its identity when performing the sales prediction task, for example, informing the large language model that it is an e-commerce platform operator responsible for predicting a sales volume score of an object across a network based on data of the object. The background information part is mainly used to introduce the background and related information of the sales prediction task to the large language model. The input data description part is mainly used to provide the feature information of the training sample to the large language model, for example, one or any combination of the basic information of the object, the picture information of the object, the SKU configuration information of the object, the price information of the object, and the seller information of the object, etc. In a specific application, the feature information may be provided in a JavaScript Object Notation (JSON) format. The output requirement part is mainly used to inform the large language model of a specific output requirement. The special description part is mainly used to prompt the large language model of a processing method in the case of special circumstances, for example, a processing or representation method when a data field is missing, special relationships between data fields, and how to verify the output result, etc. It should be noted that the sales prediction prompt template is only an example, and in actual applications, the sales prediction prompt template may be adjusted in any form according to actual needs.

At step 230, the sales prediction prompt is input into the large language model.

At step 240, a plurality of predicted sales volumes corresponding to the plurality of training samples and output by the large language model are obtained.

Here, according to the indication of the specific output requirement in the sales prediction prompt template, the predicted sales volume output by the large language model is also one of a plurality of preset discrete values, that is, a score for the sales volume of the training sample.

At step 250, a loss between the predicted sales volume corresponding to a training sample and the discrete sales label corresponding to the training sample is determined for each training sample.

At step 260, supervised fine-tuning is performed on the large language model based on the loss to obtain the supervised fine-tuned large language model.

In the embodiment of the present disclosure, a variety of specific training methods, such as a Low-Rank Adaptation (LoRA) algorithm, may be used to implement the supervised fine-tuning of the large language model.

It may be seen that according to the method described above, supervised fine-tuning may be performed on the large language model based on the discrete sales label corresponding to the training sample, to implement sales prediction and ranking. Furthermore, during the supervised fine-tuning process of the large language model, multi-dimensional features such as text and image in the training sample may be combined to further optimize the performance of the supervised fine-tuned large language model in sales prediction.

After the supervised fine-tuning of the large language model is performed by using the method described above, the sales prediction model may be obtained. Thus, after receiving an information promotion request from a user, the e-commerce platform may start to perform step 110 described above, that is, the predicted sales volume of each cold start object in the cold start object pool is determined based on the sales prediction model obtained through the supervised fine-tuning described above. It may be understood that the predicted sales volume is also one of a plurality of discrete values, that is, a score for the predicted sales volume. For example, the predicted sales volume is one of a plurality of values ranging from 0 to A.

Next, in step 120, at least one candidate cold start object may be determined from the cold start objects in the cold start object pool based on the predicted sales volumes of the cold start objects output by the sales prediction model.

It may be understood that an information promotion process may usually include three stages: recall, pre-ranking, and ranking. In the embodiment of the present disclosure, the predicted sales volume of the cold start object may be applied to one or more of the processes of recall, pre-ranking, or ranking stages, to implement effective exposure of the cold start object in various ways.

In some embodiments of the present disclosure, the predicted sales volume of the cold start object may only be applied to the recall stage. In this case, step 120 may be implemented, for example, by a procedure shown in FIG. 4. As shown in FIG. 4, a method for determining at least one candidate cold start object from the cold start objects in the cold start object pool based on the predicted sales volumes of the cold start objects output by the sales prediction model may include the following steps.

At step 410, at least one cold start object with a predicted sales volume greater than a preset sales threshold is added to a cold start object recall pool.

As described above, in the embodiment of the present disclosure, a larger the value of the predicted sales volume, a larger the corresponding predicted sales volume. A cold start object with a predicted sales volume greater than the preset sales threshold is considered as a cold start object with high sales potential, and thus may be preferentially recommended. Therefore, these cold start objects with high sales potential may be added to an object pool for subsequent pre-ranking and ranking. In the embodiment of the present disclosure, this object pool is referred to as a cold start object recall pool. Furthermore, the preset sales threshold may be flexibly set according to actual situations. It may be understood that a lower the sales threshold, a higher the probability that a cold start object is finally used as a target object (a lower the requirement); and a higher the sales threshold, a lower the probability that a cold start object is finally used as a target object (a higher the requirement).

At step 420, pre-ranking is performed on cold start objects in the cold start object recall pool based on feature information of the cold start objects, and a predetermined number of cold start objects are selected from the cold start objects and added to a ranking pool according to a pre-ranking result.

At step 430, ranking is performed on cold start objects in the ranking pool based on the feature information of the cold start objects.

At step 440, the at least one candidate cold start object is determined from the cold start objects in the ranking pool according to a ranking result.

It should be noted that for the specific implementation methods of the pre-ranking and the ranking, reference may be made to the pre-ranking and ranking algorithms used by existing recommendation platforms for information promotion, which will not be repeated herein.

It may be seen that in the above embodiment, a cold start object with a predicted sales volume greater than the preset sales threshold may be added to a separate path for object recall, and an exclusive recall quota may be added for the cold start object, thereby increasing the exposure of the cold start object with high sales potential and improving the introduction mechanism of new objects.

In some other embodiments of the present disclosure, the predicted sales volume of the cold start object may be applied to the recall process and the pre-ranking process. In this case, step 120 may be implemented, for example, by a procedure shown in FIG. 5. As shown in FIG. 5, a method for determining at least one candidate cold start object from the cold start objects in the cold start object pool based on the predicted sales volumes of the cold start objects output by the sales prediction model may include the following steps.

At step 510, at least one cold start object with a predicted sales volume greater than a preset sales threshold is added to a cold start object recall pool.

A specific implementation method of step 510 is the same as that of step 410, which will not be repeated herein.

At step 520, pre-ranking is performed on the cold start objects in the cold start object recall pool based on the feature information of the cold start objects and the predicted sales volumes of the cold start objects, and a predetermined number of cold start objects are selected from the cold start objects and added to a ranking pool according to a pre-ranking result.

Specifically, in the embodiment of the present disclosure, in step 520, the following operations are performed for each cold start object in the cold start object recall pool: first, determining a pre-ranking feature indicator of the cold start object based on the feature information of the cold start object; and performing weighted summation on the predicted sales volume of the cold start object and the feature indicator of the cold start object to obtain a pre-ranking comprehensive indicator of the cold start object, where a sum of a weight coefficient of the predicted sales volume of the cold start object and a weight coefficient of the pre-ranking feature indicator of the cold start object is equal to 1; and finally, performing pre-ranking on the cold start objects in the cold start object recall pool based on the pre-ranking comprehensive indicators of the cold start objects.

Specifically, the pre-ranking feature indicator of the cold start object determined based on the feature information of the cold start object may specifically be a pre-ranking feature indicator of the cold start object determined based on the feature information of the cold start object by using an existing pre-ranking algorithm, that is, a pre-ranking score value Score1 obtained after performing conventional pre-ranking on the cold start objects. Furthermore, the predicted sales volume of the cold start object is recorded as Score2, as a sales volume score of the cold start object. Next, weighted summation is performed on the pre-ranking feature indicator and the predicted sales volume: Score pre-ranking=α·Score2+(1−α)·Score1, to obtain the pre-ranking comprehensive indicator Score pre-ranking of the cold start object, that is, a comprehensive score for pre-ranking. Finally, the cold start objects are sorted based on the pre-ranking comprehensive indicators, to obtain the pre-ranking result. α is a weight coefficient of the predicted sales volume, which may be dynamically adjusted based on a cold start target (an initial value of α may be set to 0.2 to 0.3 according to an actual application situation).

At step 530, ranking is performed on cold start objects in the ranking pool based on the feature information of the cold start objects.

It should be noted that for the specific implementation method of the ranking, reference may be made to the ranking algorithm used by existing recommendation platforms for information promotion, which will not be repeated herein.

At step 540, the at least one candidate cold start object is determined from the cold start objects in the ranking pool according to a ranking result.

It may be seen that in the above embodiment, a cold start object with a predicted sales volume greater than the preset sales threshold may be used as a path for object recall, and the priority of an object with a high predicted sales volume among cold start objects in pre-ranking may be improved through a weighting mechanism, so as to increase an exclusive recall quota for the cold start object with high sales potential, ensure that the cold start object has certain competitiveness, and increase the exposure of the cold start object with high sales potential, thereby improving the introduction mechanism of new objects. Furthermore, in the embodiment of the present disclosure, the control of α does not significantly interfere with the distribution of pre-ranking of a mainstream object in the marked.

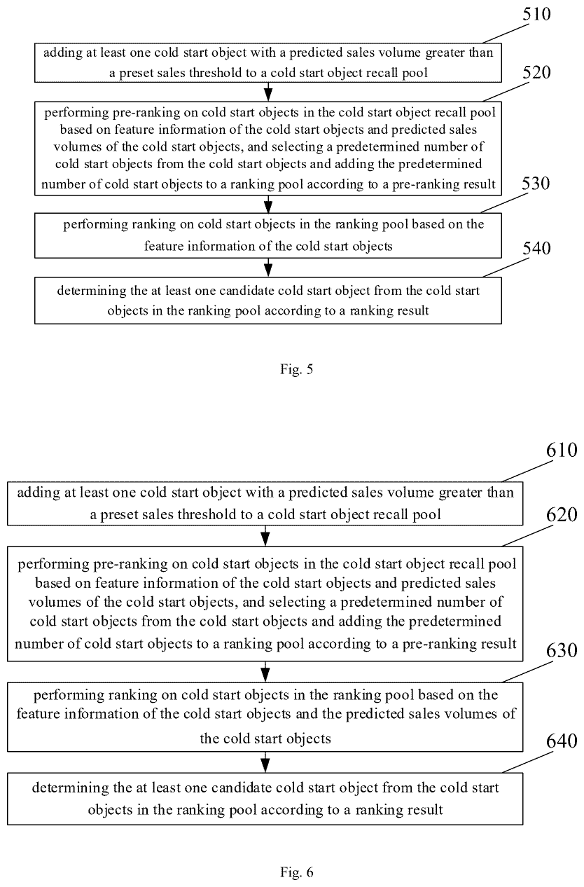

In some other embodiments of the present disclosure, the predicted sales volume of the cold start object may be applied to the recall process, the pre-ranking process, and the ranking process. In this case, step 120 may be implemented, for example, by a procedure shown in FIG. 6. As shown in FIG. 6, a method for determining at least one candidate cold start object from the cold start objects in the cold start object pool based on the predicted sales volumes of the cold start objects output by the sales prediction model may include the following steps.

At step 610, at least one cold start object with a predicted sales volume greater than a preset sales threshold is added to a cold start object recall pool.

A specific implementation method of step 610 is the same as that of step 410, which will not be repeated herein.

At step 620, pre-ranking is performed on the cold start objects in the cold start object recall pool based on the feature information of the cold start objects and the predicted sales volumes of the cold start objects, and a predetermined number of cold start objects are selected from the cold start objects and added to a ranking pool according to a pre-ranking result.

A specific implementation method of step 620 is the same as that of step 520, which will not be repeated herein.

At step 630, ranking is performed on cold start objects in the ranking pool based on the feature information of the cold start objects and the predicted sales volumes of the cold start objects.

In the embodiment of the present disclosure, step 630 may specifically include: determining a plurality of ranking features based on the feature information of the cold start objects and the predicted sales volumes of the cold start objects, where the predicted sales volume of the cold start object is used as one of the plurality of ranking features; and performing ranking on the cold start objects in the ranking pool based on the plurality of ranking features. Specifically, the predicted sales volume of the cold start object and other ranking features may be input into a gating network and a representation network to complete ranking of the cold start object. For the specific method for determining the plurality of ranking features based on the feature information of the cold start object and the specific ranking algorithm, reference may also be made to existing ranking algorithms, which will not be repeated herein.

At step 640, the at least one candidate cold start object is determined from the cold start objects in the ranking pool according to a ranking result.

It may be seen that in the above embodiment, a cold start object with a predicted sales volume greater than the preset sales threshold may be used as a path for object recall, and the priority of an object with a high predicted sales volume among cold start objects in pre-ranking may be improved through a weighting mechanism. Furthermore, the predicted sales volume of the cold start object is further used as one of the ranking features to participate in ranking, so as to increase an exclusive recall quota for the cold start object with high sales potential, thereby increasing the exposure of the cold start object with high sales potential and improving the introduction mechanism of new objects.

For step 130, the candidate non-cold start object in step 130 refers to a candidate non-cold start object obtained after performing recall, pre-ranking, and ranking on a non-cold start object. For the specific method for performing recall, pre-ranking, and ranking on the non-cold start object, reference may be made to the recall, pre-ranking, and ranking methods used by existing recommendation systems, that is, may be implemented through an existing information recommendation process, which will not be repeated herein.

Furthermore, the specific implementation method for selecting the target object for information promotion from the at least one candidate cold start object and the candidate non-cold start object in step 130 may include: first, performing hybrid ranking on the at least one candidate cold start object and the candidate non-cold start object; and then, determining the target object based on a hybrid ranking result. In the embodiment of the present disclosure, the candidate cold start object and the candidate non-cold start object may be hybrid ranked by using the hybrid ranking method used by existing recommendation platforms, to obtain the final object for information promotion.

For step 140, the operation of promoting the target object may specifically include: generating a display page for the target object based on some or all feature information of the target object; and displaying the display page of the target object to the user. In some embodiments, the display page of the target object may include: for example, displaying some or all feature information of the target object to the user, for example, displaying information such as a title, relevant description information, an associated picture, and a price of the target object.

In the information promotion method described above, the distribution of samples in the training dataset may be optimized by using the method of sales quantile sampling and label discretization, thereby effectively improving the rank correlation and prediction accuracy of the supervised fine-tuned large language model, and effectively reducing the impact of the long-tailed distribution on sales prediction. Furthermore, in the design of the input prompt, the text feature (such as the description information of the object) and the image feature (such as the picture associated with the object) are jointly learned, to improve the accuracy of sales prediction by the large language model. Furthermore, the information promotion method described above may apply the sales prediction result to applications such as information recommendation or operation support, to enhance the efficiency of introducing cold start objects in the e-commerce platform.

Specifically, the large language model may be used to extract rich object features from unstructured text data, effectively improving object selection and sales prediction capabilities, and significantly improving the prediction effect of the sales prediction model, especially in the case of data scarcity. In particular, in the new product introduction stage, by improving the sales prediction capability of new products, the effective allocation of operating resources may be guided, and an exclusive recall quota for the cold start object may be added based on the existing information recommendation process, to help the cold start object quickly break the cold start period, thereby improving the performance of new products in the e-commerce platform.

Furthermore, accurate sales prediction and ranking enable information promotion for the target object to better meet the needs of in-station users, improving the efficiency and accuracy of object introduction across the network. In particular, in terms of multi-channel promotion, sales conversion may be significantly improved, driving the growth of objects.

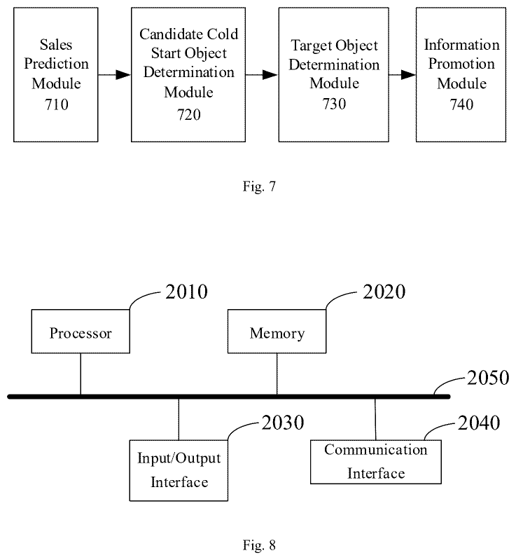

Corresponding to the information promotion method described above, some embodiments of the present disclosure further disclose an information promotion apparatus. FIG. 7 shows an internal structure of an information promotion apparatus according to an embodiment of the present disclosure. As shown in FIG. 7, the information promotion apparatus may include the following modules.

A sales prediction module 710 is configured to determine a predicted sales volume of each cold start object in a cold start object pool based on a sales prediction model, where the sales prediction model is a supervised fine-tuned large language model.

A candidate cold start object determination module 720 is configured to determine at least one candidate cold start object based on the predicted sales volume of each cold start object.

A target object determination module 730 is configured to select a target object for information promotion from the at least one candidate cold start object and a candidate non-cold start object.

An information promotion module 740 is configured to promote the target object.

It should be noted that for the implementation method of each module in the apparatus and the specific technical effect that may be achieved, reference may be made to the implementation method of each step in the foregoing embodiments, and details are not repeated herein. Furthermore, for the method for multi-round preference alignment fine-tuning and the method for supervised fine-tuning of the large language model, reference may also be made to the specific methods described in the previous embodiments, which are not repeated herein.

Based on the same inventive concept, corresponding to the method of any one of the above embodiments, the present disclosure further provides an electronic device, which includes: a memory, a processor, and a computer program stored on the memory and executable by the processor, where the computer program, when executed by the processor, causes the information promotion method of any one of the above embodiments to be implemented.

FIG. 8 shows a schematic diagram of a more specific hardware structure of an electronic device according to an embodiment of the present disclosure. The device may include: a processor 2010, a memory 2020, an input/output interface 2030, a communication interface 2040, and a bus 2050. The processor 2010, the memory 2020, the input/output interface 2030, and the communication interface 2040 are communicatively connected to each other within the device through the bus 2050.

The processor 2010 may be implemented using a general-purpose central processing unit (CPU), a microprocessor, an application specific integrated circuit (ASIC), or one or more integrated circuits, to execute a related program, so as to implement the technical solutions provided in the embodiments of the present specification.

The memory 2020 may be implemented using a read-only memory (ROM), a random access memory (RAM), a static storage device, a dynamic storage device, etc. The memory 2020 may store an operating system and other applications, and when the technical solutions provided in the embodiments of the present specification are implemented by software or firmware, relevant program code is stored in the memory 2020 and called by the processor 2010 for execution.

The input/output interface 2030 is used to connect to an input/output device to enable information input and output. The input/output device may be configured as a component in the device or external to the device to provide a corresponding function. The input device may include a microphone, various sensors, etc., and the output device may include a display, a speaker, a vibrator, an indicator light, etc.

The communication interface 2040 is used to connect to a communication module (not shown) to enable communication interaction between the device and other devices. The communication module may communicate in a wired (e.g., a USB, a network cable, etc.) or wireless (e.g., a mobile network, Wi-Fi, Bluetooth, etc.) manner.

The bus 2050 includes a path for transferring information between components (for example, the processor 2010, the memory 2020, the input/output interface 2030, and the communication interface 2040) of the device.

It should be noted that although only the processor 2010, the memory 2020, the input/output interface 2030, the communication interface 2040, and the bus 2050 are shown in the device, during a specific implementation, the device may further include other components necessary for proper operation. Furthermore, it may be understood by those skilled in the art that the device may include only the components necessary to implement the solutions of the embodiments of the present specification, and not necessarily include all of the components shown in the figure.

The electronic device of the above embodiment is configured to perform the corresponding information promotion method in any one of the above embodiments, and has the beneficial effects of the corresponding method embodiment, which are not repeated herein.

Based on the same inventive concept, corresponding to the method of any one of the above embodiments, the present disclosure further provides a non-transitory computer-readable storage medium, which stores computer instructions, where the computer instructions are used to cause a computer to perform the information promotion method of any one of the above embodiments.

The computer-readable medium in this embodiment includes permanent and non-permanent, removable and non-removable media, and information storage may be implemented by using any method or technology. Information may be computer-readable instructions, data structures, modules of a program, or other data. Examples of the computer storage medium include but are not limited to a phase-change random access memory (PRAM), a static random access memory (SRAM), a dynamic random access memory (DRAM), another type of random access memory (RAM), a read-only memory (ROM), an electrically erasable programmable read-only memory (EEPROM), a flash memory or another memory technology, a compact disc read-only memory (CD-ROM), a digital versatile disc (DVD) or another optical storage, a cassette tape, tape or disk storage or another magnetic storage device, or any other non-transmission medium that may be used to store information that may be accessed by a computing device.

The computer instructions stored on the storage medium of the above embodiment are used to cause the computer to perform the information promotion method of any one of the above embodiments, and have the beneficial effects of the corresponding method embodiment, which are not repeated herein.

It should be understood by those of ordinary skill in the art that the discussion of any one of the above embodiments is merely exemplary, and is not intended to imply that the scope of the present disclosure (including the claims) is limited to these examples; and with the concept of the present disclosure, the technical features in the above embodiments or different embodiments may also be combined, steps may be implemented in any order, and many other changes may be made to different aspects of the embodiments of the present disclosure as described above and are not provided in detail for simplicity.

In addition, to simplify description and discussion and avoid obscuring an understanding of the embodiments of the present disclosure, well-known power/ground connections to an integrated circuit (IC) chip and other components may or may not be shown in the drawings that are provided. Furthermore, the apparatus may be shown in the form of a block diagram to avoid obscuring an understanding of the embodiments of the present disclosure, and the following fact is also taken into account: details regarding the implementation of the apparatus in the form of block diagram are highly dependent upon a platform on which the embodiments of the present disclosure are to be implemented (i.e., such details should be fully understood by those skilled in the art). Where the specific details (e.g., circuitry) are set forth to describe the exemplary embodiments of the present disclosure, it will be apparent to those skilled in the art that the embodiments of the present disclosure may be implemented without these specific details or with variations to these specific details. These descriptions should therefore be considered illustrative rather than limiting.

Although the present disclosure has been described with reference to the specific embodiments of the present disclosure, many substitutions, modifications, and variations of these embodiments will be apparent to those of ordinary skill in the art from the foregoing description. For example, the discussed embodiments may be used for other memory architectures such as a dynamic RAM (DRAM).

An embodiment of the present disclosure further provides a computer program product, which includes computer program instructions that, when executed on a computer, cause the computer to perform the information promotion method described above.

The embodiments of the present disclosure are intended to cover all such substitutions, modifications, and variations that fall within the broad scope of the appended claims. Therefore, any omissions, modifications, equivalent substitutions, improvements etc. made within the spirit and principle of the embodiments of the present disclosure are intended to be included within the scope of protection of the present disclosure.

1. An information promotion method, comprising:
determining a predicted sales volume of each cold start object in a cold start object pool based on a sales prediction model, wherein the sales prediction model is a supervised fine-tuned large language model;
determining at least one candidate cold start object based on the predicted sales volume of each cold start object;
selecting a target object for information promotion from the at least one candidate cold start object and a candidate non-cold start object; and
promoting the target object.

2. The method of claim 1, further comprising:
constructing a training dataset, wherein the training dataset comprises a plurality of training samples and discrete sales labels corresponding to the training samples;
generating a sales prediction prompt for each training sample in the training dataset;
inputting the sales prediction prompt into a large language model;
obtaining a plurality of predicted sales volumes corresponding to the plurality of training samples and output by the large language model;
determining a loss between a predicted sales volume corresponding to a training sample and a discrete sales label corresponding to the training sample for each training sample; and
performing supervised fine-tuning on the large language model based on the loss to obtain the supervised fine-tuned large language model.

3. The method of claim 2, wherein the constructing a training dataset comprises:
labeling each sample of a plurality of samples in a preset sample dataset with a sales value corresponding to the sample;
for a sample with a sales label value of zero, setting the discrete sales label corresponding to the sample to zero;
for a sample with a non-zero sales label value, dividing the sample into N sample groups according to a preset number of groups N and an N quantile to which the sales label value corresponding to the sample belongs, and setting a same discrete sales label for samples in each sample group, respectively, wherein the larger the sales label value, the larger the discrete sales label set for the sample group where the sample is located in, and N is a positive integer; and
for each discrete sales label, extracting a predetermined number of samples from samples corresponding to the discrete sales label as the training samples.

4. The method of claim 2, wherein the generating a sales prediction prompt for each training sample in the training dataset comprises:
generating the sales prediction prompt based on a preset sales prediction prompt template and feature information of the training sample,
wherein the feature information of the training sample comprises one or more selected from a group of: basic information of an object, picture information of the object, stock keeping unit (SKU) configuration information of the object, price information of the object, and seller information of the object; and
the preset sales prediction prompt template comprises: a role description part, background information part, an input data description part, an output requirement part, and a special description part.

5. The method of claim 1, wherein the determining at least one candidate cold start object based on the predicted sales volume of each cold start object comprises:
adding at least one cold start object with a predicted sales volume greater than a preset sales threshold to a cold start object recall pool;
performing pre-ranking on cold start objects in the cold start object recall pool based on feature information of the cold start objects, and selecting a predetermined number of cold start objects from the cold start objects and adding the predetermined number of cold start objects to a ranking pool according to a pre-ranking result;
performing ranking on cold start objects in the ranking pool based on the feature information of the cold start objects; and
determining the at least one candidate cold start object from the cold start objects in the ranking pool according to a ranking result.

6. The method of claim 1, wherein the determining at least one candidate cold start object based on the predicted sales volume of each cold start object comprises:
adding at least one cold start object with a predicted sales volume greater than a preset sales threshold to a cold start object recall pool;
performing pre-ranking on cold start objects in the cold start object recall pool based on feature information of the cold start objects and predicted sales volumes of the cold start objects, and selecting a predetermined number of cold start objects from the cold start objects and adding the predetermined number of cold start objects to a ranking pool according to a pre-ranking result;
performing ranking on cold start objects in the ranking pool based on the feature information of the cold start objects; and
determining the at least one candidate cold start object from the cold start objects in the ranking pool according to a ranking result.

7. The method of claim 1, wherein the determining at least one candidate cold start object based on the predicted sales volume of each cold start object comprises:
adding at least one cold start object with a predicted sales volume greater than a preset sales threshold to a cold start object recall pool;
performing pre-ranking on cold start objects in the cold start object recall pool based on feature information of the cold start objects and predicted sales volumes of the cold start objects, and selecting a predetermined number of cold start objects from the cold start objects and adding the predetermined number of cold start objects to a ranking pool according to a pre-ranking result;
performing ranking on cold start objects in the ranking pool based on the feature information of the cold start objects and the predicted sales volumes of the cold start objects; and
determining the at least one candidate cold start object from the cold start objects in the ranking pool according to a ranking result.

8. The method of claim 6, wherein the performing pre-ranking on cold start objects in the cold start object recall pool based on feature information of the cold start objects and predicted sales volumes of the cold start objects comprises:
performing following operations for each cold start object in the cold start object recall pool: determining a pre-ranking feature indicator of the cold start object based on the feature information of the cold start object, and performing weighted summation on the predicted sales volume of the cold start object and the feature indicator of the cold start object to obtain a pre-ranking comprehensive indicator of the cold start object, wherein a sum of a weight coefficient of the predicted sales volume of the cold start object and a weight coefficient of the pre-ranking feature indicator of the cold start object is equal to 1; and
performing pre-ranking on the cold start objects in the cold start object recall pool based on pre-ranking comprehensive indicators of the cold start objects.

9. The method of claim 7, wherein the performing ranking on cold start objects in the ranking pool based on the feature information of the cold start objects and predicted sales volumes of the cold start objects comprises:
determining a plurality of ranking features based on the feature information of the cold start objects and the predicted sales volumes of the cold start objects, wherein the predicted sales volume of the cold start object is used as one of the plurality of ranking features; and
performing ranking on the cold start objects in the ranking pool based on the plurality of ranking features.

10. The method of claim 1, wherein the determining a target object for information promotion from the at least one candidate cold start object and a candidate non-cold start object comprises:
performing hybrid ranking on the at least one candidate cold start object and the candidate non-cold start object; and
determining the target object based on a hybrid ranking result.

11. The method of claim 7, wherein the performing pre-ranking on cold start objects in the cold start object recall pool based on feature information of the cold start objects and predicted sales volumes of the cold start objects comprises:
performing following operations for each cold start object in the cold start object recall pool: determining a pre-ranking feature indicator of the cold start object based on the feature information of the cold start object, and performing weighted summation on the predicted sales volume of the cold start object and the feature indicator of the cold start object to obtain a pre-ranking comprehensive indicator of the cold start object, wherein a sum of a weight coefficient of the predicted sales volume of the cold start object and a weight coefficient of the pre-ranking feature indicator of the cold start object is equal to 1; and
performing pre-ranking on the cold start objects in the cold start object recall pool based on pre-ranking comprehensive indicators of the cold start objects.

12. An electronic device, comprising:
at least one processor; and
a memory in communicative connection with the at least one processor,
wherein the memory stores a computer program that is capable of being executed by the at least one processor, and the computer program is executed by the at least one processor to cause the at least one processor to execute an information promotion method, wherein the method comprises:
determining a predicted sales volume of each cold start object in a cold start object pool based on a sales prediction model, wherein the sales prediction model is a supervised fine-tuned large language model;
determining at least one candidate cold start object based on the predicted sales volume of each cold start object;
selecting a target object for information promotion from the at least one candidate cold start object and a candidate non-cold start object; and
promoting the target object.

13. The electronic device of claim 12, wherein the method further comprises:
constructing a training dataset, wherein the training dataset comprises a plurality of training samples and discrete sales labels corresponding to the training samples;
generating a sales prediction prompt for each training sample in the training dataset;
inputting the sales prediction prompt into a large language model;
obtaining a plurality of predicted sales volumes corresponding to the plurality of training samples and output by the large language model;
determining a loss between a predicted sales volume corresponding to a training sample and a discrete sales label corresponding to the training sample for each training sample; and
performing supervised fine-tuning on the large language model based on the loss to obtain the supervised fine-tuned large language model.

14. The electronic device of claim 13, wherein the constructing a training dataset comprises:
labeling each sample of a plurality of samples in a preset sample dataset with a sales value corresponding to the sample;
for a sample with a sales label value of zero, setting the discrete sales label corresponding to the sample to zero;
for a sample with a non-zero sales label value, dividing the sample into N sample groups according to a preset number of groups N and an N quantile to which the sales label value corresponding to the sample belongs, and setting a same discrete sales label for samples in each sample group, respectively, wherein the larger the sales label value, the larger the discrete sales label set for the sample group where the sample is located in, and N is a positive integer; and
for each discrete sales label, extracting a predetermined number of samples from samples corresponding to the discrete sales label as the training samples.

15. The electronic device of claim 13, wherein the generating a sales prediction prompt for each training sample in the training dataset comprises:
generating the sales prediction prompt based on a preset sales prediction prompt template and feature information of the training sample,
wherein the feature information of the training sample comprises one or more selected from a group of: basic information of an object, picture information of the object, stock keeping unit (SKU) configuration information of the object, price information of the object, and seller information of the object; and
the preset sales prediction prompt template comprises: a role description part, background information part, an input data description part, an output requirement part, and a special description part.

16. The electronic device of claim 12, wherein the determining at least one candidate cold start object based on the predicted sales volume of each cold start object comprises:
adding at least one cold start object with a predicted sales volume greater than a preset sales threshold to a cold start object recall pool;
performing pre-ranking on cold start objects in the cold start object recall pool based on feature information of the cold start objects, and selecting a predetermined number of cold start objects from the cold start objects and adding the predetermined number of cold start objects to a ranking pool according to a pre-ranking result;
performing ranking on cold start objects in the ranking pool based on the feature information of the cold start objects; and
determining the at least one candidate cold start object from the cold start objects in the ranking pool according to a ranking result.

17. The electronic device of claim 12, wherein the determining at least one candidate cold start object based on the predicted sales volume of each cold start object comprises:
adding at least one cold start object with a predicted sales volume greater than a preset sales threshold to a cold start object recall pool;
performing pre-ranking on cold start objects in the cold start object recall pool based on feature information of the cold start objects and predicted sales volumes of the cold start objects, and selecting a predetermined number of cold start objects from the cold start objects and adding the predetermined number of cold start objects to a ranking pool according to a pre-ranking result;
performing ranking on cold start objects in the ranking pool based on the feature information of the cold start objects; and
determining the at least one candidate cold start object from the cold start objects in the ranking pool according to a ranking result.

18. The electronic device of claim 12, wherein the determining at least one candidate cold start object based on the predicted sales volume of each cold start object comprises:
adding at least one cold start object with a predicted sales volume greater than a preset sales threshold to a cold start object recall pool;
performing pre-ranking on cold start objects in the cold start object recall pool based on feature information of the cold start objects and predicted sales volumes of the cold start objects, and selecting a predetermined number of cold start objects from the cold start objects and adding the predetermined number of cold start objects to a ranking pool according to a pre-ranking result;
performing ranking on cold start objects in the ranking pool based on the feature information of the cold start objects and the predicted sales volumes of the cold start objects; and
determining the at least one candidate cold start object from the cold start objects in the ranking pool according to a ranking result.

19. The electronic device of claim 17, wherein the performing pre-ranking on cold start objects in the cold start object recall pool based on feature information of the cold start objects and predicted sales volumes of the cold start objects comprises:
performing following operations for each cold start object in the cold start object recall pool: determining a pre-ranking feature indicator of the cold start object based on the feature information of the cold start object, and performing weighted summation on the predicted sales volume of the cold start object and the feature indicator of the cold start object to obtain a pre-ranking comprehensive indicator of the cold start object, wherein a sum of a weight coefficient of the predicted sales volume of the cold start object and a weight coefficient of the pre-ranking feature indicator of the cold start object is equal to 1; and
performing pre-ranking on the cold start objects in the cold start object recall pool based on pre-ranking comprehensive indicators of the cold start objects.

20. A non-transitory computer-readable storage medium, wherein the non-transitory computer-readable storage medium stores computer instructions, wherein the computer instructions, when executed by a processor, cause the processor to implement an information promotion method, and the method comprises:
determining a predicted sales volume of each cold start object in a cold start object pool based on a sales prediction model, wherein the sales prediction model is a supervised fine-tuned large language model;
determining at least one candidate cold start object based on the predicted sales volume of each cold start object;
selecting a target object for information promotion from the at least one candidate cold start object and a candidate non-cold start object; and
promoting the target object.
